(19) United States
(12) Patent Application Publication
(10) Pub. No.: US 2017/0211753 A1
(43) Pub. Date: Jul. 27, 2017

(54) LED TUBE LAMP

(71) Applicant: JIAXING SUPER LIGHTING ELECTRIC APPLIANCE CO.,LTD, Zhejiang (CN)

(72) Inventors: TAO JIANG, Zhejiang (CN); HONG XU, Zhejiang (CN); LI-QIN LI, Zhejiang (CN); CHANG YANG, Zhejiang (CN)

(21) Appl. No.: 15/483,368

(22) Filed: Apr. 10, 2017

Related U.S. Application Data
(63) Continuation-in-part of application No. 14/865,387, filed on Sep. 25, 2015, now Pat. No. 9,609,711.
Application No. 14/865,387 is a continuation-in-part of application No. 15/056,121, filed on Feb. 29, 2016, now Pat. No. 9,447,929.
Application No. 15/056,121 is a continuation-in-part of application No. 15/168,962, filed on May 31, 2016.
Application No. 15/168,962 is a continuation-in-part of application No. PCT/CN2015/096502, filed on Dec. 5, 2015.
Application No. PCT/CN2015/096502 is a continuation-in-part of application No. 15/087,092, filed on Mar. 31, 2016.
Application No. 15/087,092 is a continuation of application No. 15/211,717, filed on Jul. 15, 2016, now Pat. No. 9,618,168.

(30) Foreign Application Priority Data
Sep. 28, 2014 (CN) 201410507660.9
Sep. 28, 2014 (CN) 201410508899.8
Nov. 6, 2014 (CN) 201410623355.6
Dec. 5, 2014 (CN) 201410734425.5
Feb. 12, 2015 (CN) 201510075925.7
Mar. 10, 2015 (CN) 201510104823.3
Mar. 25, 2015 (CN) 201510133689.X
Mar. 26, 2015 (CN) 201510134586.5
Mar. 27, 2015 (CN) 201510136796.8
Apr. 3, 2015 (CN) 201510155807.7
Apr. 14, 2015 (CN) 201510173861.4
Apr. 22, 2015 (CN) 201510193980.6
May 19, 2015 (CN) 201510259151.3
May 22, 2015 (CN) 201510268927.8
May 29, 2015 (CN) 201510284720.X
Jun. 10, 2015 (CN) 201510315636.X
Jun. 12, 2015 (CN) 201510324394.0
Jun. 17, 2015 (CN) 201510338027.6
Jun. 26, 2015 (CN) 201510364735.7
Jun. 26, 2015 (CN) 201510372375.5
Jun. 26, 2015 (CN) 201510373492.3
Jun. 29, 2015 (CN) 201510378322.4
Jul. 2, 2015 (CN) 201510391910.1
Jul. 10, 2015 (CN) 201510406595.5
Jul. 20, 2015 (CN) 201510428680.1
Jul. 27, 2015 (CN) 201510448220.5
Aug. 7, 2015 (CN) 201510482944.1
Aug. 8, 2015 (CN) 201510483475.5
Aug. 8, 2015 (CN) 201510486115.0
Aug. 14, 2015 (CN) 201510499512.1
Sep. 2, 2015 (CN) 201510555543.4
Sep. 6, 2015 (CN) 201510557717.0
Sep. 18, 2015 (CN) 201510595173.7
Oct. 8, 2015 (CN) 201510645134.3
Oct. 29, 2015 (CN) 201510716899.1
Nov. 27, 2015 (CN) 201510848766.X
Dec. 2, 2015 (CN) 201510868263.9
Jan. 22, 2016 (CN) 201610044148.4
Mar. 25, 2016 (CN) 201610177706.4
May 18, 2016 (CN) 201610327806.0

(51) Int. Cl. F21K 9/272; F21V 29/83; F21V 3/02; F21V 23/06; F21V 17/10; F21K 9/278; F21V 3/04

(52) U.S. Cl. CPC F21K 9/272; F21K 9/278; F21V 29/83; F21V 3/0418; F21V 23/06; F21V 17/101; F21V 3/02; F21Y 2115/10

(57) ABSTRACT

An LED tube lamp includes a glass tube, a plurality of LED light sources, two end caps respectively sleeving two end portions of the glass tube, a power supply in one of the end caps or separately in both of the end caps, and an LED light strip in the glass tube. The plurality of LED light sources is on the LED light strip. Each of the end caps comprises a plurality of openings formed thereon. The plurality of openings dissipating heat resulted from the power supply are divided into two sets. The two sets of the plurality of openings are symmetric to each other with respect to a virtual central axis of the end cap.

### CROSS-REFERENCE TO RELATED APPLICATIONS

This application is continuation application of U.S. application Ser. No. 15/211,717 filed on Jul. 15, 2016 which is a continuation-in-part application claiming benefits of U.S. application Ser. No. 14/865,387 filed on 2015 Sep. 25, U.S. application Ser. No. 15/056,121 filed on 2016 Feb. 29, and U.S. application Ser. No. 15/168,962 filed on 2016 May 31, the disclosures of which are incorporated herein in their entirety by reference.

### TECHNICAL FIELD

The instant disclosure relates to illumination devices, and, more particularly, to an LED tube lamp and components thereof comprising the LED light sources, a tube, electronic components, and end caps.

### RELATED ART

LED lighting technology is rapidly developing to replace traditional incandescent and fluorescent lightings. LED tube lamps are mercury-free in comparison with fluorescent tube lamps that need to be filled with inert air and mercury. Thus, it is not surprising that LED tube lamps are becoming a highly desired illumination option among different available lighting systems used in homes and workplaces, which used to be dominated by traditional lighting options such as compact fluorescent light bulbs (CFLs) and fluorescent tube lamps. Benefits of LED tube lamps include improved durability and longevity and far less energy consumption; therefore, when taking into account all factors, they would typically be considered as a cost effective lighting option.

The basic structure of the traditional LED tube lamps include a tube, two end caps at two ends of the tube, a substrate inside the tube, LEDs on the substrate, and a power supply inside the end caps. The substrate disposed inside the tube and having LEDs mounted on is rigid and straight printed circuit board, which makes the tube remain a straight appearance even it is partially ruptured or broken. As a result, user cannot easily aware that the tube is damaged and might be exposed to a dangerous situation.

In addition, the rigid substrate of the traditional LED tube lamp is typically electrically connected with the end caps by way of wire bonding, in which the wires may be easily damaged and even broken due to any move during manufacturing, transportation, and usage of the LED tube lamp and therefore may disable the LED tube lamp.

As the development of LED chips, electro-optical conversion efficiency becomes higher and heat generated from the conversion becomes less. Accordingly, apparatuses utilizing LED chips seldom use ventilating holes to dissipating the heat.

Further, the tube and the end caps of the traditional LED tube lamp are often secured together by tight fit, making the reliability cannot be further improved.

### SUMMARY

To address the above issue, the instant disclosure provides embodiments of an LED tube lamp.

According to an embodiment, an LED tube lamp includes a glass tube having two end portions, a plurality of LED light sources, two end caps respectively sleeve the two end portions of the glass tube, a power supply in one of the end caps or separately in both of the end caps, and an LED light strip on an inner surface of the glass tube. The glass tube is covered by a heat shrink sleeve. The glass tube and the end cap are secured by a hot melt adhesive. The plurality of LED light sources is on the LED light strip. Each of the end caps comprises an electrically insulating tube, two conductive pins on the electrically insulating tube; and at least two heat-dissipating openings on the electrically insulating tube symmetric to each other with respect to a plane passing through the middle of a line connecting the two conductive pins and perpendicular to the line connecting the two conductive pins.

According to an embodiment, the hot melt adhesive is, respectively, disposed on the outer surface of the end portions and the shape of the disposed hot melt adhesive is substantially a circle from the side view of the glass tube.

According to an embodiment, the at least two heat-dissipating openings are on a surface of the electrically insulating tube on which the two conductive pins are disposed.

According to an embodiment, the at least two heat-dissipating openings are separately in a shape of an arc.

According to an embodiment, the at least two heat-dissipating openings are in a shape of arcs with different sizes.

According to an embodiment, the sizes of the arcs of the at least two heat-dissipating openings gradually vary.

According to an embodiment, the heat shrink sleeve is substantially transparent with respect to the wavelength of light from the LED light sources.

According to an embodiment, at least a part of the openings are arranged along an arc and spaced apart from each other.

According to an embodiment, the heat and pressure inside the end cap increase during the heating and solidification of the hot melt adhesive, and are then released through at least one opening on the end cap.

According to an embodiment, an LED tube lamp includes a glass tube having an inner surface and an outer surface, a plurality of LED light sources, two end caps respectively at two opposite ends of the glass tube, a power supply in one of the end caps or separately in both of the end caps, and an LED light strip on the inner surface of the glass tube. The plurality of LED light sources is on the LED light strip. Each of the end caps comprises a plurality of openings formed thereon. The plurality of openings dissipating heat resulted from the power supply are divided into two sets. The two sets of the plurality of openings are symmetric to each other with respect to a virtual central axis of the end cap. At least part of the inner surface of the glass tube is formed with a rough surface.

According to an embodiment, the LED tube lamp comprises a hot melt adhesive. The end cap is adhered to one end of the glass tube via the hot melt adhesive.

According to another embodiment, the plurality of openings dissipate heat resulted from the power supply.

According to another embodiment, the hot melt adhesive is heated to be expansive and flowing during a process of having the glass tube and the end cap adhered. The plurality of openings dissipate heat to have the hot melt adhesive cooled and solidified.

According to another embodiment, an LED tube lamp includes a glass tube, a plurality of LED light sources, two end caps respectively at two opposite ends of the glass tube, a power supply in one of the end caps or separately in both of the end caps, and an LED light strip in the glass tube. The plurality of LED light sources is on the LED light strip. Each of the end caps comprises two conductive pins and a plurality of heat-dissipating openings. The two conductive pins are on a surface of the end cap. The plurality of heat-dissipating openings is on the surface of the end cap and divided into two sets. The two sets of the heat-dissipating openings are symmetric to each other with respect to a plane passing through the two conductive pins.

### BRIEF DESCRIPTION OF THE DRAWINGS

FIG. 1 illustrates a perspective view of an LED tube lamp according to an embodiment of the instant disclosure;

FIG. 2 illustrates an exploded view of an LED tube lamp according to an embodiment of the instant disclosure;

FIG. 3 illustrates a part of cross section of FIG. 2 along line A-A′;

FIG. 4 illustrates a part of cross section of FIG. 2 along line B-B′;

FIG. 5 illustrates an exploded view of an LED tube lamp including two parts of a power supply according to an embodiment of the instant disclosure;

FIG. 6 illustrates an exploded view of an LED tube lamp including a heat shrink sleeve according to an embodiment of the instant disclosure;

FIG. 7 illustrates a partial view of a bendable circuit sheet of an LED light strip and a power supply apart from each other according to an embodiment of the instant disclosure;

FIG. 8 illustrates a partial view of the bendable circuit sheet of the LED light strip and the power supply soldered to each other according to an embodiment of the instant disclosure;

FIGS. 9 to 11 illustrate a soldering process of the bendable circuit sheet of the LED light strip and the power supply according to an embodiment of the instant disclosure;

FIGS. 12 and 13 illustrate a bendable circuit sheet of an LED light strip and a power supply electrically connected to each other by a pair of jack/plug connectors according to an embodiment of the instant disclosure;

FIG. 14 is a perspective view schematically illustrating an LED tube lamp according to an embodiment of the instant disclosure;

FIG. 15 an exemplary exploded view schematically illustrating the LED tube lamp shown in FIG. 14; and

FIG. 16 is a perspective view schematically illustrating front and top of an end cap of the LED tube lamp according to one embodiment of the instant disclosure.

### DETAILED DESCRIPTION

The instant disclosure provides an LED tube lamp to solve the abovementioned problems. The instant disclosure will now be described more fully hereinafter with reference to the accompanying drawings, in which exemplary embodiments of the disclosure are shown. This disclosure may, however, be embodied in many different forms and should not be construed as limitation to the embodiments set forth herein. Rather, these embodiments are provided so that this disclosure will be thorough and complete, and will fully convey the scope of the disclosure to those skilled in the art. Like reference numerals refer to like elements throughout.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” or “includes” and/or “including” or “has” and/or “having” when used herein, specify the presence of stated features, regions, integers, steps, operations, elements, and/or components, but do not preclude the presence or addition of one or more other features, regions, integers, steps, operations, elements, components, and/or groups thereof.

It will be understood that the term “and/or” includes any and all combinations of one or more of the associated listed items. It will also be understood that, although the terms first, second, third etc. may be used herein to describe various elements, components, regions, parts and/or sections, these elements, components, regions, parts and/or sections should not be limited by these terms. These terms are only used to distinguish one element, component, region, part or section from another element, component, region, part or section. Thus, a first element, component, region, part or section discussed below could be termed a second element, component, region, part or section without departing from the teachings of the present disclosure.

The following description with reference to the accompanying drawings is provided to explain the exemplary embodiments of the disclosure. Note that in the case of no conflict, the embodiments of the present disclosure and the features of the embodiments may be arbitrarily combined with each other.

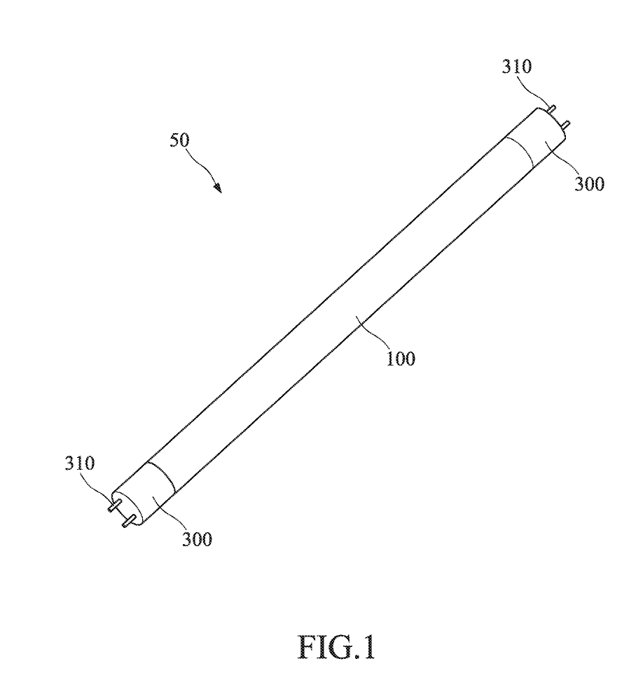

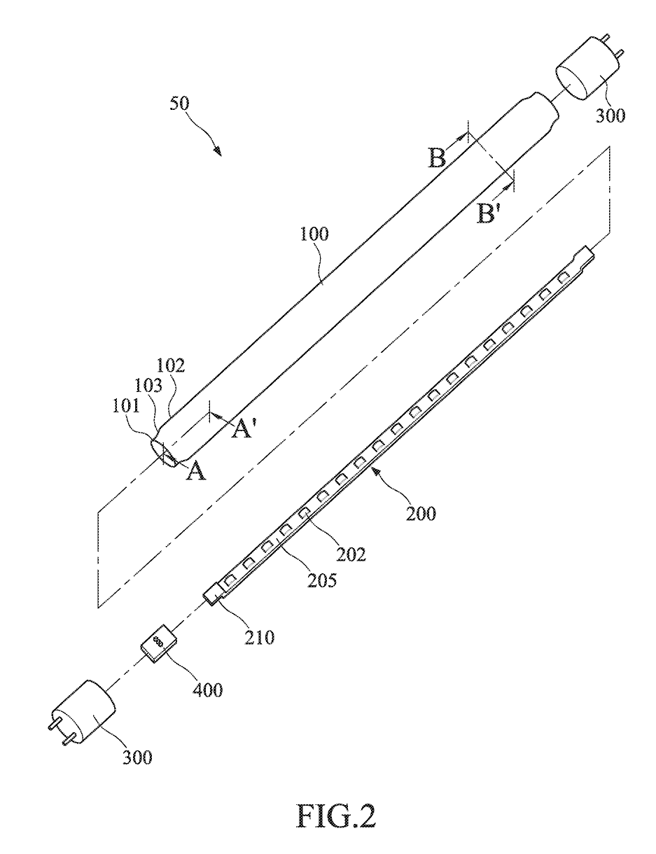

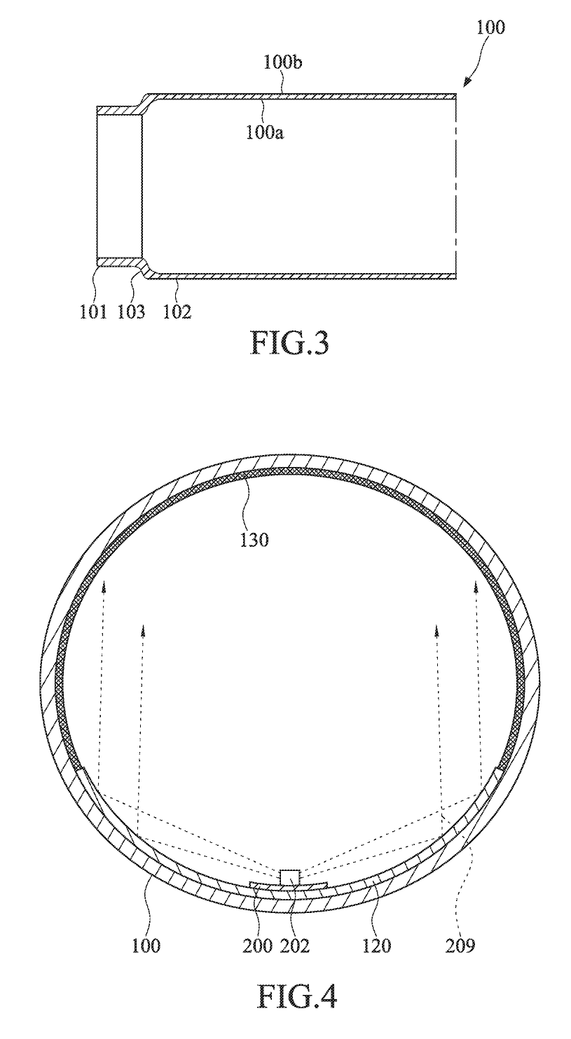

Referring to FIG. 1, FIG. 2, and FIG. 3, the instant disclosure provides an embodiment of an LED tube lamp 50 including a glass tube 100, an LED light strip 200, two end caps 300, and a power supply 400. The glass tube 100 includes an inner surface 100a and an outer surface 100b. The LED light strip 200 is disposed inside the glass tube 100 and has a bendable circuit sheet 205 mounted on the inner surface 100a of the glass tube 100. The two end caps 300, which can have the same size or have different sizes, are respectively disposed on two ends of the glass tube 100 and secured with the glass tube 100 by a hot melt adhesive. The hot melt adhesive may be disposed around the surrounding surfaces between the glass tube 100 and the end caps 300, respectively. In this embodiment, the end caps 300 sleeve, respectively, two end portions of the glass tube 100 and the hot melt adhesive may be surroundingly disposed on the outer surface of the end portions of the glass tube 100. Accordingly, the shape of the disposed hot melt adhesive is substantially a circle from the side view of the glass tube 100 (like the view of FIG. 4). The heat generated during the heating process of the hot melt adhesive will be in a shape of a circle. The degree of vacuum of the glass tube 100 is below 0.001 Pa˜1 Pa, and reduce the problem of internal damp. After heating up the hot melt adhesive, and upon expansion due to heat absorption, the hot melt adhesive flows, and then solidifies upon cooling, thereby bonding together the end cap 300 to the glass tube 100 (not shown). The volume of the hot melt adhesive may expand to about 1.3 times the original size when heated from room temperature (e.g., between about 15 and 30 degrees Celsius) to about 200 to 250 degrees Celsius. The end cap 300 and the end of the glass tube 100 could be secured by using the hot melt adhesive and therefore qualified in a torque test of about 1.5 to about 5 newton-meters (Nt-m) and/or in a bending test of about 5 to about 10 newton-meters (Nt-m). During the heating and solidification of the hot melt adhesive, the heat and pressure inside the end cap increase and are then released through at least one opening on the end cap 300. After the hot melt adhesive hardens, the end cap 300 can be firmly fixed to the glass tube 100. Under the circumstances, the end cap 300 and the glass tube 100 is hard to disassemble unless the hardened hot melt adhesive returns to liquid state by certain process. The design of the LED tube lamp 50 is to take into account both the convenience regarding the assembling process of the LED tube lamp 50 and the robustness regarding the assembled LED tube lamp 50. Several LED light sources 202 are disposed on the bendable circuit sheet 205 of the LED light strip 200, and the power supply 400 is disposed in one of the end caps 300. The LED light sources 202 and the power supply 400 can be electrically connected to each other directly via the bendable circuit sheet 205 of the LED light strip 200. Middle part of the bendable circuit sheet 205 can be mounted on the inner surface 100a of the glass tube 100. Instead, at least one of the two opposite, short edges of the bendable circuit sheet 205 is not mounted on the inner surface 100a of the glass tube 100 and may be formed as a freely extending end portion 210. The freely extending end portions 210 extends outside the glass tube 100 through one of two opposite ends of the glass tube 100 along the axial direction of the glass tube 100. The freely extending end portion 210 can extend into the end caps 300 and can be electrically connected to the power supply 400 directly. The power supply 400 may be in the form of a single integrated unit (e.g., with all components of the power supply 400 are within a body) disposed in an end cap 300 at one end of the glass tube 100. Alternatively, the power supply 400 may be in form of two separate parts (e.g., with the components of the power supply 400 are separated into two pieces) respectively disposed in two end caps 300. The power supply may supply or provide power from external signal(s), such as from an AC power line or from a ballast, to an LED module and the LED light sources. Each of the end caps 300 includes a pair of hollow conductive pins 310 utilized for being connected to an outer electrical power source. When the LED tube lamp 50 is installed to a lamp base, the hollow conductive pins 310 are plugged into corresponding conductive sockets of the lamp base such that the LED tube lamp 50 can be electrically connected to the lamp base.

In one embodiment, the LED light strip 200 comprises a bendable circuit sheet 205 which includes a wiring layer and a dielectric layer that are in a stacked arrangement, wherein the wiring layer and the dielectric layer have same area or the wiring layer has a bit less area (not shown) than the dielectric layer. The LED light source 202 is disposed on a surface of the wiring layer away from the dielectric layer. In other words, the dielectric layer is disposed on the wiring layer away from the LED light sources 202. The wiring layer is electrically connected to the power supply 400 to carry direct current (DC) signals. Meanwhile, an adhesive sheet is disposed on a surface of the dielectric layer away from the wiring layer to bond and to fix the dielectric layer to the inner circumferential surface of the glass tube 100. The wiring layer can be a metal layer serving as a power supply layer, or can be bonding wires such as copper wire. In an alternative embodiment, the LED light strip 200 further includes a circuit protection layer (not shown) cover each outer surface of the wiring layer and the dielectric layer. In another alternative embodiment, the dielectric layer can be omitted, in which the wiring layer is directly bonded to the inner circumferential surface of the glass tube 100. The circuit protection layer can be an ink material, possessing functions as solder resist and optical reflectance. Alternatively, the bendable circuit sheet 205 is a one-layered structure which is consist of one wiring layer only, and then the surface of the wiring layer is covered with a circuit protection layer of ink material as mentioned above, wherein an opening is configured over the circuit protection layer to electrically connect the LED light source 202 with the wiring layer. Whether the wiring layer has a one-layered, or two-layered structure, the circuit protective layer can be adopted. The circuit protection layer can be disposed on the side/surface of the LED light strip 200, such as the same surface of the wiring layer which has the LED light source 202 disposed thereon.

It should be noted that, in the present embodiment, the bendable circuit sheet 205 is a one-layered structure made of just one layer of the wiring layer, or a two-layered structure (made of one layer of the wiring layer and one layer of the dielectric layer), and thus would be more bendable or flexible to curl than the conventional three-layered flexible substrate. As a result, the bendable circuit sheet 205 (the LED light strip 200) of the present embodiment can be installed in a glass tube 100 that is of a customized shape or non-linear shape, and the bendable circuit sheet 205 can be mounted touching the sidewall of the glass tube 100. The bendable circuit sheet 205 mounted closely to the inner surface of the tube wall is one preferred configuration, and the fewer number of layers thereof, the better the heat dissipation effect, and the lower the material cost. Of course, the bendable circuit sheet 205 is not limited to being a one-layered or two-layered structure only; in other embodiments, the bendable circuit sheet 205 can include multiple layers of the wiring layers and multiple layers of the dielectric layers, in which the dielectric layers and the wiring layers are sequentially stacked in a staggered manner, respectively, to be disposed on the surface of the one wiring layer that is opposite from the surface of the one wiring layer which has the LED light source 202 disposed thereon.

In one embodiment, the LED light strip 200 includes a bendable circuit sheet 205 having in sequence a first wiring layer, a dielectric layer, and a second wiring layer (not shown). The thickness of the second wiring layer is greater than that of the first wiring layer, and/or the projected length of the LED light strip 200 is greater than that of the glass tube 100. The end region of the light strip 200 extending beyond the end portion of the glass tube 100 without disposition of the LED light source 202 is formed with two separate through holes to respectively electrically communicate the first wiring layer and the second wiring layer (not shown). The through holes are not communicated to each other to avoid short.

In this way, the greater thickness of the second wiring layer allows the second wiring layer to support the first wiring layer and the dielectric layer, and meanwhile allow the LED light strip 200 to be mounted onto the inner circumferential surface without being liable to shift or deform, and thus the yield rate of product can be improved. In addition, the first wiring layer and the second wiring layer are in electrical communication such that the circuit layout of the first wiring layer can be extended downward to the second wiring layer to reach the circuit layout of the entire LED light strip 200. In some circumstances, the first wiring layer connects the anode and the second wiring layer connects the cathode. Moreover, since the land for the circuit layout becomes two-layered, the area of each single layer and therefore the width of the LED light strip 200 can be reduced such that more LED light strips 200 can be put on a production line to increase productivity. Furthermore, the first wiring layer and the second wiring layer of the end region of the LED light strip 200 that extends beyond the end portion of the tube 100 without disposition of the LED light source 202 can be used to accomplish the circuit layout of a power supply 400 so that the power supply 400 can be directly disposed on the bendable circuit sheet 205 of the LED light strip 200.

In another embodiment, the projected length of the bendable circuit sheet 205 as the LED light strip 200 in a longitudinal projection is larger than the length of the glass tube 100. The LED light source 202 is disposed on the uppermost layer of the wiring layers, and is electrically connected to the power supply 400 through the (uppermost) wiring layer. Furthermore, the inner peripheral surface of the glass tube 100 or the outer circumferential surface thereof is covered with an adhesive film (not shown), for the sake of isolating the inner content from outside content of the glass tube 100 after the glass tube 100 has been ruptured. The present embodiment has the adhesive film coated on the inner peripheral surface of the glass tube 100 (not shown).

Moreover, in some embodiments, the projected length of the bendable circuit sheet is greater than the length of the glass tube 100 (not including the length of the two end caps 300 respectively connected to two ends of the glass tube 100), or at least greater than a central portion of the glass tube 100 between two transition regions (e.g., where the circumference of the tube narrows) on either end. In one embodiment, the longitudinally projected length of the bendable circuit sheet as the LED light strip 200 is larger than the length of the glass tube 100.

As shown in FIG. 3, the glass tube 100 includes a main body region 102, two rear end regions 101, and two two-arc-shaped transition regions 103 narrowed down or tapering smoothly and continuously from the main body region to the rear end regions connecting the main body region 102 and the rear end regions 101. In other words, in the transition regions 103, the glass tube 100 narrows, or tapers to have a smaller diameter when moving along the length of the glass tube 100 from the main body region 102 to the rear end regions 101. The tapering/narrowing may occur in a continuous, smooth manner (e.g., to be a smooth curve without any linear angles). By avoiding angles, in particular any acute angles, the glass tube 100 is less likely to break or crack under pressure. Furthermore, the transition region 103 is formed by two curves at both ends, wherein one curve is toward inside of the glass tube 100 and the other curve is toward outside of the glass tube 100. For example, one curve closer to the main body region 102 is convex from the perspective of an inside of the glass tube 100 and one curve closer to the rear end region 101 is concave from the perspective of an inside of the glass tube 100. The transition region 103 of the glass tube 100 in one embodiment includes only smooth curves, and does not include any angled surface portions. The outer diameter of the rear end region 101 is smaller than that of the main body region 102. Therefore, a height difference between the rear end region 101 and the main body region 102 is formed to avoid adhesives applied on the rear end region 101 being overflowed onto the main body region 102, and thereby saves manpower for removing the overflowed adhesive and increases productivity.

In one embodiment, at least part of the inner surface 100a of the glass tube 100 has a rough surface and the roughness of the inner surface 100a is higher than that of the outer surface 100b, such that the light from the LED light sources 202 can be uniformly spread when transmitting through the glass tube 100. Since LED light sources 202 consists of several point light sources (LED dies), each LED light source 202 casts a cone of light, which results in non-uniformity of light output intensity. With the rough surface, the light from LED light sources 202 will be diffused before transmitting through the glass tube 100 and the uniformity of light output is improved thereby. In one embodiment, the roughness of the inner surface 100a may be substantially from 0.1 to 40 the light from LED light sources 202 will be well diffused before entirely transmitting through the glass tube 100 and the uniformity of light output is substantially improved. However, in some embodiments, the inner surface 100a of the glass tube 100 does not have the roughness surface.

In one embodiment, as shown in FIG. 4, the rough surface may be formed with a light scattering region 130. Since LED light sources 202 consists of several point light sources (LED dies), each LED light source 202 casts a cone of light, which results in non-uniformity of light output intensity. With the light scattering region 130, the light from LED light sources 202 will be scattered before entirely transmitting through the glass tube 100 and the uniformity of light output is substantially improved.

In one embodiment, as shown in FIG. 4, the glass tube 100 may further include a reflective film 120 disposed on a part of the inner surface 100a of the glass tube 100. In some embodiments, the reflective film 120 may be positioned on two sides of the LED light strip 200. As shown in FIG. 4, part of light 209 from LED light sources 202 are reflected by the reflective films 120 such that the light 209 from the LED light sources 202 can be centralized to a determined direction. And, in some embodiment, a ratio of a length of the reflective film 120 disposed on the inner surface 100a of the glass tube 100 extending along the circumferential direction of the glass tube 100 to a circumferential length of the glass tube 100 may be about 0.3 to 0.5, which means about 30% to 50% of the inner surface area may be covered by the reflective film 120. The reflective film 120 may be made of PET with some refractive materials such as strontium phosphate or barium sulfate or any combination thereof, with a thickness between about 140 μm and about 350 μm or between about 150 μm and about 220 μm for a more preferred effect in some embodiments. In some embodiments, only the part of the inner surface 100a which is not covered by the reflective film 120 is formed with the light scattering region 130 as shown in FIG. 4. In other words, the reflective film 120 is disposed on a part of the inner surface 100a of the glass tube 100 which is not formed with the rough surface or the light scattering region 130.

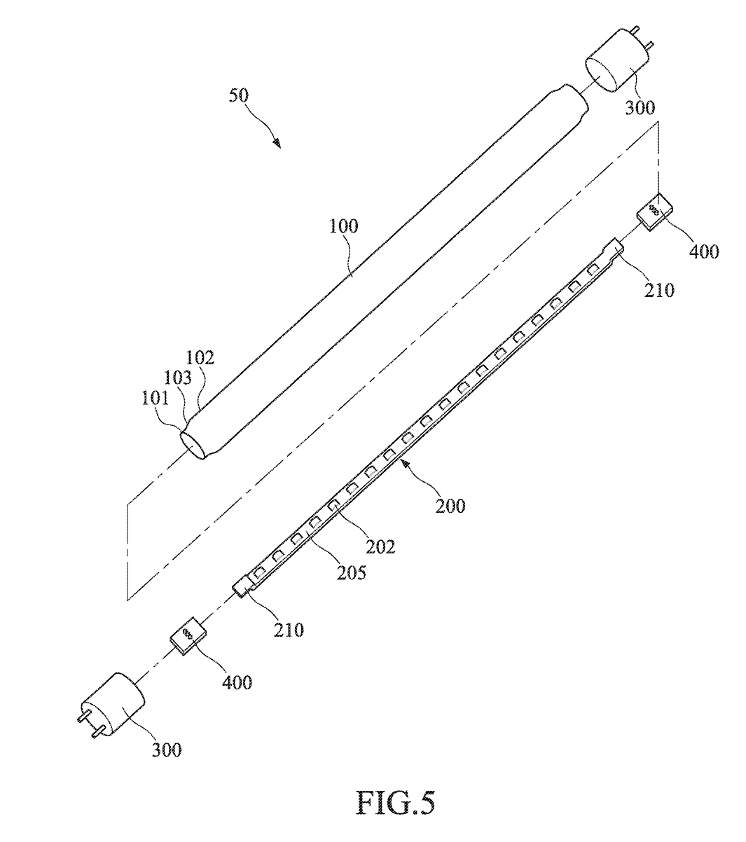

In one embodiment, as shown in FIG. 5, two opposite, short edges of the bendable circuit sheet 205 may be formed as two freely extending end portions 210, and two parts of a power supply 400 are respectively disposed in the two end caps 300. The two freely extending end portions 210 respectively extends outside the glass tube 100 through two opposite ends of the glass tube 100 along the axial direction of the glass tube 100, such that can respectively extend into the two end caps 300 and be respectively electrically connected to the two parts of a power supply 400 directly.

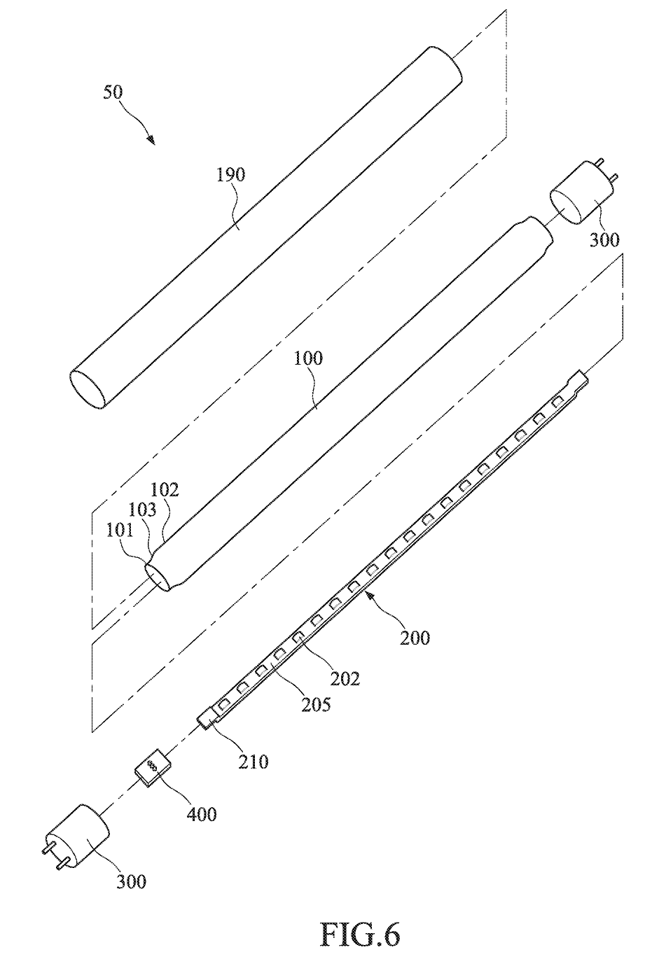

Referring to FIG. 6, the LED tube lamp 50 may have a heat shrink sleeve 190 covering on the outer surface 100b of the glass tube 100. In some embodiments, the heat shrink sleeve 190 may have a thickness ranging between 20 μm and 200 μm and is substantially transparent with respect to the wavelength of light from the LED light sources 202. In some embodiments, the heat shrink sleeve 190 may be made of PFA (perfluoroalkoxy) or PTFE (polytetrafluoroethylene). The heat shrink sleeve 190 may be slightly larger than the glass tube 100, and may be shrunk and tightly cover the outer surface 100b of the glass tube 100 while being heated to an appropriate temperature (ex, 260° C. for PFA and PTFE).

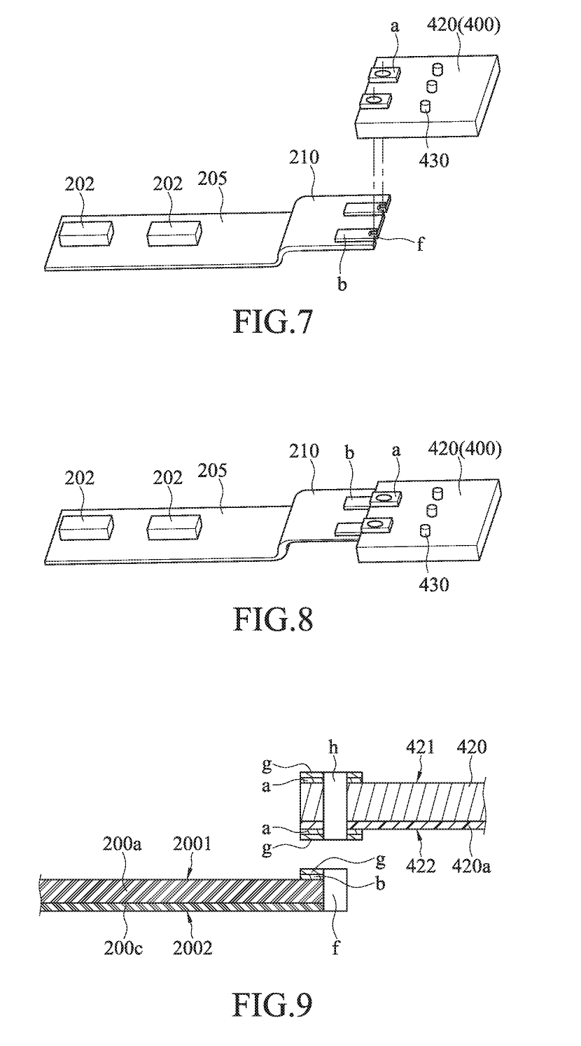

Referring to FIG. 7 to FIG. 11, FIG. 7 and FIG. 8 are respectively partial views of the bendable circuit sheet 205 of the LED light strip 200 and the printed circuit board 420 of the power supply 400 apart from and soldered to each other. FIG. 9 to FIG. 11 illustrate a soldering process of the bendable circuit sheet 205 of the LED light strip 200 and the printed circuit board 420 of the power supply 400. In the embodiment, the bendable circuit sheet 205 of the LED light strip 200 and the freely extending end portions 210 have the same structure. In some embodiments, the power supply 400 includes at least one electronic component 430 disposed on one side of the printed circuit board 420, and the freely extending end portion 210 is electrically connected to the printed circuit board 420 directly through the other side which has no electronic component 430 disposed thereon. The freely extending end portions 210 are the portions of two opposite ends of the bendable circuit sheet 205 of the LED light strip 200 and are utilized for being connected to the printed circuit board 420 of the power supply 400. The LED light strip 200 and the power supply 400 can be electrically connected to each other by soldering. Two opposite ends of the bendable circuit sheet 205 of the LED light strip 200 are utilized for being respectively soldered directly to the printed circuit board 420 of the two parts of a power supply 400. In other embodiments, only one end of the bendable circuit sheet 205 of the LED light strip 200 is soldered directly to the printed circuit board 420 of the power supply 400. The bendable circuit sheet 205 of the LED light strip 200 includes a circuit layer 200a and a circuit protecting layer 200c over a side of the circuit layer 200a. Moreover, the bendable circuit sheet 205 of the LED light strip 200 includes two opposite surfaces which are a first surface 2001 and a second surface 2002. The first surface 2001 is the one on the circuit layer 200a and away from the circuit protecting layer 200c. The second surface 2002 is the other one on the circuit protecting layer 200c and away from the circuit layer 200a. Several LED light sources 202 are disposed on the first surface 2001 and are electrically connected to circuits of the circuit layer 200a. The circuit protecting layer 200c has less electrical and thermal conductivity but being beneficial to protect the circuits. The first surface 2001 of the bendable circuit sheet 205 of the LED light strip 200 includes soldering pads “b”. Soldering material “g” can be placed on the soldering pads “b”. In the embodiment, the LED light strip 200 further includes a notch “f”. The notch “f” is disposed on an edge of the end of the bendable circuit sheet 205 of the LED light strip 200 soldered directly to the printed circuit board 420 of the power supply 400. The printed circuit board 420 includes a power circuit layer 420a and soldering pads “a”. Moreover, the printed circuit board 420 includes two opposite surfaces which are a first surface 421 and a second surface 422. The second surface 422 is the one on the power circuit layer 420a. The soldering pads “a” are respectively disposed on the first surface 421 and the second surface 422. The soldering pads “a” on the first surface 421 are corresponding to those on the second surface 422. Soldering material “g” can be placed on the soldering pad “a”. In the embodiment, considering the stability of soldering and the optimization of automatic process, the bendable circuit sheet 205 of LED light strip 200 is disposed below the printed circuit board 420 (the direction is referred to FIG. 9). That is to say, the first surface 2001 of the bendable circuit sheet 205 of the LED light strip 200 is connected to the second surface 422 of the printed circuit board 420 of the power supply 400.

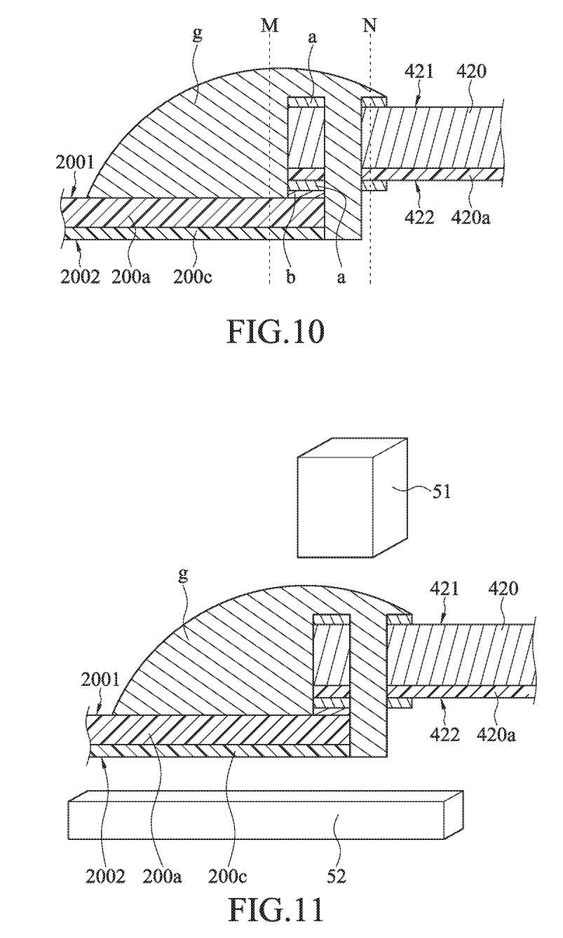

As shown in FIG. 10 and FIG. 11, in the soldering process of the bendable circuit sheet 205 of the LED light strip 200 and the printed circuit board 420 of the power supply 400, the circuit protecting layer 200c of the bendable circuit sheet 205 of the LED light strip 200 is placed on a supporting table 52 (i.e., the second surface 2002 of the bendable circuit sheet 205 of the LED light strip 200 contacts the supporting table 52) in advance. The soldering pads “a” on the second surface 422 of the printed circuit board 420 of the power supply 400 directly sufficiently contact the soldering pads “b” on the first surface 2001 of the bendable circuit sheet 205 of the LED light strip 200. A thermo-compression heating head 51 presses on a portion where the bendable circuit sheet 205 of the LED light strip 200 and the printed circuit board 420 of the power supply 400 are soldered to each other. When soldering, the soldering pads “b” on the first surface 2001 of the bendable circuit sheet 205 of the LED light strip 200 contact the soldering pads “a” on the second surface 422 of the printed circuit board 420 of the power supply 400, and the soldering pads “a” on the first surface 421 of the printed circuit board 420 of the power supply 400 contact the thermo-compression heating head 51. Under the circumstances, the heat from the soldering thermo-compression heating head 51 can directly transmit through the soldering pads “a” on the first surface 421 of the printed circuit board 420 of the power supply 400 and the soldering pads “a” on the second surface 422 of the printed circuit board 420 of the power supply 400 to the soldering pads “b” on the first surface 2001 of the bendable circuit sheet 205 of the LED light strip 200. The transmission of the heat between the thermo-compression heating head 51 and the soldering pads “a” and b is not likely to be affected by the circuit protecting layer 200c which has relatively less thermal conductivity, and, consequently, the efficiency and stability regarding the connections and soldering process of the soldering pads “a” and “b” of the printed circuit board 420 of the power supply 400 and the bendable circuit sheet 205 of the LED light strip 200 can be improved. As shown in FIG. 10, the printed circuit board 420 of the power supply 400 and the bendable circuit sheet 205 of the LED light strip 200 are firmly connected to each other by the soldering material “g”. Components between the virtual line M and the virtual line N of FIG. 10 from top to bottom are the soldering pads “a” on the first surface 421 of printed circuit board 420, the printed circuit board 420, the power circuit layer 420a, the soldering pads “a” on the second surface 422 of printed circuit board 420, the soldering pads “b” on the first surface 2001 of the bendable circuit sheet 205 of the LED light strip 200, the circuit layer 200a of the bendable circuit sheet 205 of the LED light strip 200, and the circuit protecting layer 200c of the bendable circuit sheet 205 of the LED light strip 200. The connection of the printed circuit board 420 of the power supply 400 and the bendable circuit sheet 205 of LED light strip 200 are firm and stable.

In other embodiments, an additional circuit protecting layer can be disposed over the first surface 2001 of the circuit layer 200a. In other words, the circuit layer 200a is sandwiched between two circuit protecting layers, and therefore the first surface 2001 of the circuit layer 200a can be protected by the circuit protecting layer. A part of the circuit layer 200a (the part having the soldering pads “b”) is exposed for being connected to the soldering pads “a” of the printed circuit board 420 of the power supply 400. Under the circumstances, a part of the bottom of the LED light source 202 contacts the circuit protecting layer on the first surface 2001 of the circuit layer 200a, and the other part of the bottom of the LED light source 202 contacts the circuit layer 200a.

In addition, according to the embodiment shown in FIG. 7 to FIG. 11, the printed circuit board 420 of the power supply 400 further includes through holes “h” passing through the soldering pads “a”. In an automatic soldering process, when the thermo-compression heating head 51 automatically presses the printed circuit board 420 of the power supply 400, the soldering material “g” on the soldering pads “a” can be pushed into the through holes “h” by the thermo-compression heating head 51 accordingly, which fits the needs of automatic process.

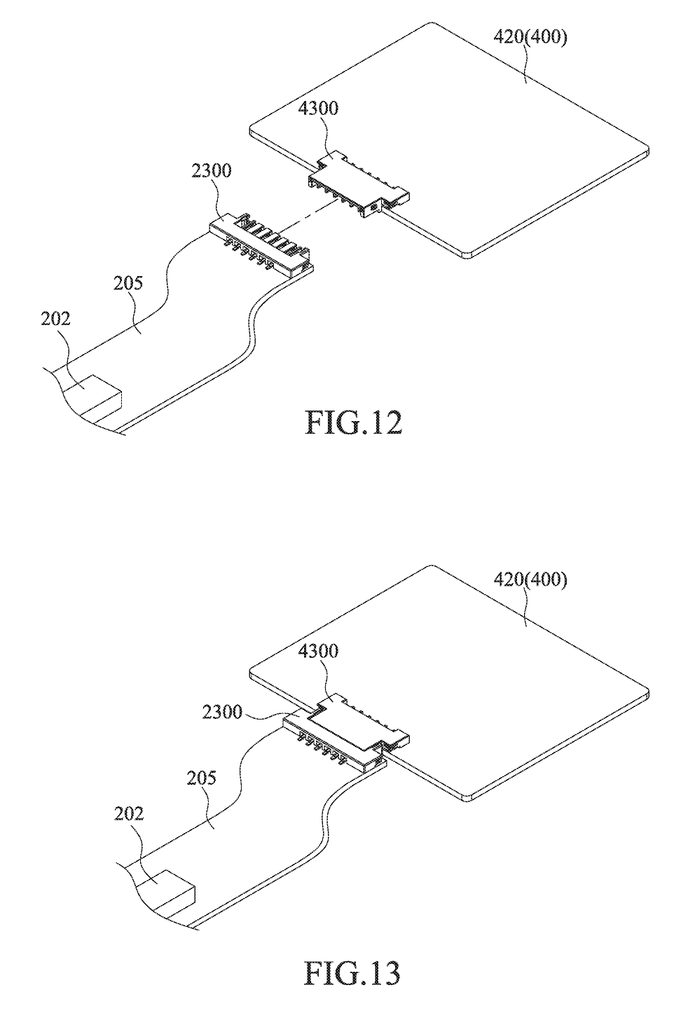

Referring to FIG. 12 and FIG. 13, in some embodiments, the bendable circuit sheet 205 of the LED light strip 200 and the printed circuit board 420 of the power supply 400 are electrically connected to each other by a pair of jack/plug connectors rather than by soldering. As shown in FIG. 12, the freely extending end portion 210 of the bendable circuit sheet 205 of the LED light strip 200 has a first electric connector 2300, and the printed circuit board 420 of the power supply 400 has a second electric connector 4300 which is capable of being connected with the first connector 2300. Since the LED light strip 200 and the power supply 400 are electrically connected to each other by a pair of jack/plug connectors rather than by soldering, the end cap 300 and the power supply 400 can be replaceable.

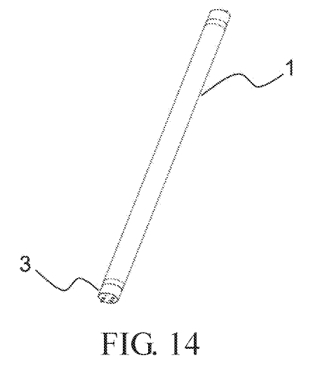

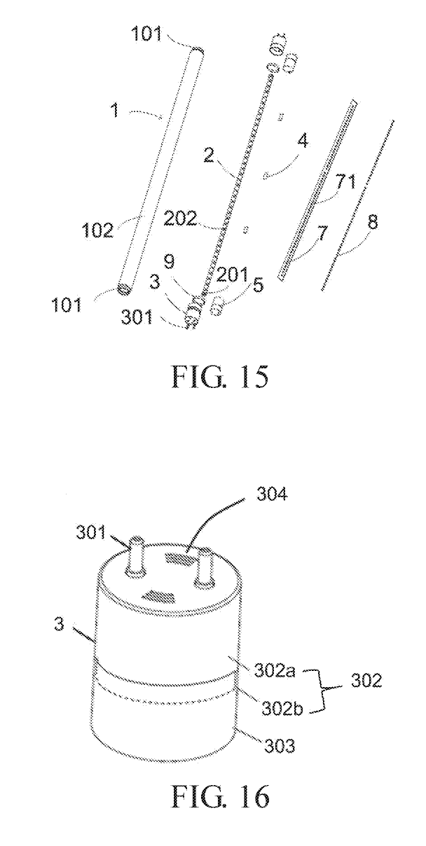

Referring to FIGS. 14 and 15, an LED tube lamp of one embodiment of the present invention includes a glass tube 1, an LED light strip 2 disposed inside the glass tube 1, and two end caps 3 respectively disposed at two ends of the glass tube 1.

Referring to FIGS. 15 and 16, in one embodiment, the end cap 3 may have openings 304 to dissipate heat generated by the power supply modules inside the end cap 3 so as to prevent a high temperature condition inside the end cap 3 that might reduce reliability. In some embodiments, the openings 304 are in a shape of an arc; especially in a shape of three arcs with different size. In one embodiment, the openings 304 are in a shape of three arcs with gradually varying size. The openings 304 on the end cap 3 can be in any one of the above-mentioned shape or any combination thereof. At least a part of the openings are arranged along an arc and spaced apart from each other.

Referring to FIG. 16, in one embodiment, each end cap 3 includes an electrically insulating tube 302, a thermal conductive member 303 sleeving over the electrically insulating tube 302, and two hollow conductive pins 301 disposed on the electrically insulating tube 302. The thermal conductive member 303 can be a metal ring that is tubular in shape. According to FIGS. 15 and 16, the openings 304 on the electrically insulating tube symmetric to each other with respect to a vertical central plane passing through the middle of a line connecting the two conductive pins 301 and the vertical central plane is perpendicular to the line connecting the two conductive pins 301. The openings 304 are on a surface of the electrically insulating tube 302 on which the two conductive pins 301 are disposed.

The openings 304 symmetrically disposed on the electrically insulating tube 302 is capable of efficiently dissipating heat generated during the heating and solidification of the hot melt adhesive. Specifically, during heating and solidification of the hot melt adhesive, the hot melt adhesive circularly surrounding the end portions of the glass tube 100 will be heated and generates heat which is circularly surrounding the glass tube 100. Since the holes 304 are symmetrically arranged on the electrically insulating tube 302, the heat could be efficiently dissipated through the opening 304 which is the closest to the heat-generating sources (hot melt adhesive). In addition, the holes 304 may be used to dissipate heat generated by power supply 400 during the use of the LED tube lamp 50. In one embodiment, the components of the power supply 400 may be arranged symmetrically in one of the end caps, separately in both of the end caps, or in the glass tube 100 in accordance with the symmetrical arrangement of the holes 304. Accordingly, the heat generated from the components of the power supply can be dissipated through the hole 301 which is the closest to the component.

If any terms in this application conflict with terms used in any application(s) from which this application claims priority, or terms incorporated by reference into this application or the application(s) from which this application claims priority, a construction based on the terms as used or defined in this application should be applied.

While the instant disclosure related to an LED tube lamp has been described by way of example and in terms of the preferred embodiments, it is to be understood that the instant disclosure needs not be limited to the disclosed embodiments. For anyone skilled in the art, various modifications and improvements within the spirit of the instant disclosure are covered under the scope of the instant disclosure. The covered scope of the instant disclosure is based on the appended claims.

What is claimed is:

1. An LED tube lamp, comprising:
a glass tube covered by a heat shrink sleeve and having two end portions;
a plurality of LED light sources;
two end caps respectively sleeve the two end portions of the glass tube, the glass tube and the end cap are secured by a hot melt adhesive;
a power supply in one of the end caps or separately in both of the end caps; and
an LED light strip on an inner surface of the glass tube, the plurality of LED light sources being on the LED light strip;
wherein each of the end caps comprises:
an electrically insulating tube;
two conductive pins on the electrically insulating tube; and
at least two heat-dissipating openings on the electrically insulating tube symmetric to each other with respect to a plane passing through the middle of a line connecting the two conductive pins and perpendicular to the line connecting the two conductive pins.

2. The LED tube lamp according to claim 1, wherein the hot melt adhesive is, respectively, disposed on the outer surface of the end portions, and the shape of the disposed hot melt adhesive is substantially a circle from the side view of the glass tube.

3. The LED tube lamp according to claim 2, wherein the at least two heat-dissipating openings are on a surface of the electrically insulating tube on which the two conductive pins are disposed.

4. The LED tube lamp according to claim 3, wherein the at least two heat-dissipating openings are separately in a shape of an arc.

5. The LED tube lamp according to claim 4, wherein the at least two heat-dissipating openings are in a shape of arcs with different sizes.

6. The LED tube lamp according to claim 5, wherein the sizes of the arcs of the at least two heat-dissipating openings gradually vary.

7. The LED tube lamp according to claim 6, wherein the heat shrink sleeve is substantially transparent with respect to the wavelength of light from the LED light sources.

8. The LED tube lamp according to claim 1, wherein the number of the at least two heat-dissipating openings is six in two sets, and the three heat-dissipating openings in one set are in a shape of three arcs with gradually varying sizes.

9. The LED tube lamp according to claim 1, wherein at least a part of the openings are arranged along an arc and spaced apart from each other.

10. The LED tube lamp according to claim 1, wherein the heat and pressure inside the end cap increase during heating and solidification of the hot melt adhesive, and are then released through at least one of the heat-dissipating openings.

11. An LED tube lamp, comprising:
a glass tube comprising an inner surface and an outer surface, at least part of the inner surface of the glass tube has a rough surface, the glass tube having two end portions;
a plurality of LED light sources;
two end caps respectively sleeve the two end portions of the glass tube;
a power supply in one of the end caps or separately in both of the end caps; and
an LED light strip on the inner surface of the glass tube, the plurality of LED light sources being on the LED light strip;
wherein each of the end caps comprises a plurality of openings thereon, and the two sets of the plurality of openings are symmetric to each other with respect to a virtual central axis of the end cap.

12. The LED tube lamp according to claim 11, wherein the roughness of the rough surface is substantially from 0.1 to 40 μm.

13. The LED tube lamp according to claim 12, further comprising a hot melt adhesive, wherein the end cap is adhered to one end of the glass tube via the hot melt adhesive.

14. The LED tube lamp according to claim 13, wherein the plurality of openings dissipate heat resulted from the power supply.

15. The LED tube lamp according to claim 13, wherein the hot melt adhesive is heated to be expansive and flowing during a process of having the glass tube and the end cap adhered, and the plurality of openings dissipate heat to have the hot melt adhesive cooled and solidified.

16. The LED tube lamp according to claim 11, wherein the plurality of openings are separately in a shape of an arc.

17. The LED tube lamp according to claim 16, wherein the number of the plurality of openings is three, and the three openings are in a shape of three arcs with gradually varying sizes.

18. The LED tube lamp according to claim 11, wherein the plurality of openings are separately in a shape of a circle.

19. The LED tube lamp according to claim 18, wherein the number of the plurality of openings is three, and the three openings are arranged in a shape of an arc.

20. The LED tube lamp according to claim 12, wherein at least a part of the openings are arranged along an arc and spaced apart from each other.

21. The LED tube lamp according to claim 12, wherein the heat and pressure inside the end cap increase during the heating and solidification of the hot melt adhesive, and are then released through at least one opening on the end cap.

22. An LED tube lamp, comprising:
a glass tube having two end portions;
a plurality of LED light sources;
two end caps respectively sleeve the two end portions of the glass tube, the glass tube and the end cap being secured by a hot melt adhesive, each of the end caps comprising two conductive pins and a plurality of heat-dissipating openings, the two conductive pins being on a surface of the end cap, the plurality of heat-dissipating openings being on the surface of the end cap and divided into two sets, and the two sets of the heat-dissipating openings being symmetric to each other with respect to a plane passing through the two conductive pins; and
an LED light strip on an inner surface of the glass tube, the plurality of LED light sources being on the LED light strip.

23. The LED tube lamp according to claim 22, further comprising a power supply in one of the end caps or separately in both of the end caps, wherein the plurality of heat-dissipating openings dissipate heat resulted from the power supply.

24. The LED tube lamp according to claim 23, wherein the plurality of heat-dissipating openings are separately in a shape of an arc.

25. The LED tube lamp according to claim 23, wherein the surface of the end cap is vertical to the length direction of the glass tube.

26. The LED tube lamp according to claim 24, wherein the plurality of heat-dissipating openings are in a shape of arcs with different sizes.

27. The LED tube lamp according to claim 26, wherein the sizes of the arcs of the plurality of heat-dissipating openings gradually vary.

28. The LED tube lamp according to claim 23, wherein the plurality of heat-dissipating openings are separately in a shape of a circle.

29. The LED tube lamp according to claim 28, wherein the number of the plurality of heat-dissipating openings is three, and the three heat-dissipating openings are arranged in a shape of an arc.

30. The LED tube lamp according to claim 23, wherein the plurality of heat-dissipating openings are a combination in a shape of an arc and a circle.

31. The LED tube lamp according to claim 23, wherein at least a part of the openings are arranged along an arc and spaced apart from each other.

32. The LED tube lamp according to claim 23, wherein the heat and pressure inside the end cap increase during the heating and solidification of the hot melt adhesive, and are then released through at least one opening on the end cap.

33. An LED tube lamp, comprising:
a glass tube covered by a heat shrink sleeve;
a plurality of LED light sources;
two end caps respectively at two opposite ends of the glass tube, the glass tube and the end cap are secured by a hot melt adhesive;
a power supply in one of the end caps or separately in both of the end caps; and
an LED light strip on an inner surface of the glass tube, the plurality of LED light sources being on the LED light strip;
wherein each of the end caps comprises:
an electrically insulating tube;
two conductive pins on the electrically insulating tube; and
at least two heat-dissipating openings on the electrically insulating tube symmetric to each other with respect to a plane passing through the middle of a line connecting the two conductive pins and perpendicular to the line connecting the two conductive pins.

34. The LED tube lamp according to claim 33, wherein the hot melt adhesive is, respectively, disposed on the outer surface of the glass tube, the shape of the disposed hot melt adhesive is substantially a circle from the side view of the glass tube, and the at least two heat-dissipating openings are separately in a shape of an arc.
